(19) United States
(12) Patent Application Publication
(10) Pub. No.: US 2014/0255547 A1
(43) Pub. Date: Sep. 11, 2014

(54) FOOD BAR MADE WITH HOMOGENIZED GRAINS RETAINING ENDOSPERM AND GERM

(71) Applicant: A&B PROCESS SYSTEMS CORPORATION, Stratford, WI (US)

(72) Inventor: Thomas RANK, Roscoe, IL (US)

(73) Assignee: A&B PROCESS SYSTEMS CORPORATION, Stratford, WI (US)

(21) Appl. No.: 14/204,495

(22) Filed: Mar. 11, 2014

Related U.S. Application Data
(60) Provisional application No. 61/775,990, filed on Mar. 11, 2013.

(51) Int. Cl. A23L 1/00; A23L 1/105; A23L 1/10

(52) U.S. Cl. CPC A23L 1/0076; A23L 1/1033; A23L 1/1055
USPC 426/28; 426/618; 426/627; 426/311; 426/61

(57) ABSTRACT

A food bar is formed by a homogenizing of cooked grains including intact endosperm and germ combined with a fermented dairy product and then mixed with other ingredients and then formed into a bar form. Direct processing of more complete grains provides cost savings, energy savings, and nutritional advantages, for the finished product along with a more digestible and textures needed for the particular market.

### CROSS REFERENCE TO RELATED APPLICATION

This application claims the benefit of U.S. Provisional Application No. 61/775,990 filed Mar. 11, 2013 and hereby incorporated by reference.

### BACKGROUND OF THE INVENTION

Generally foods that process entire grains on-site of manufacturing are limited to cereal producers. They cook, process, extrude and dry the final grain formula to produce dry cereal. Those products are dry and crunchy, intended for breakfast.

### SUMMARY OF THE INVENTION

The present invention provides a method of producing a food bar that may process grains retaining both the endosperm and the germ through a cooking and homogenizing process. The advantage of this invention includes cost savings (ingredient and energy) by eliminating the need to separate the germ which retains beneficial attributes of the grain, particularly when whole grains are used.

In one embodiment, the method provides a method of manufacturing of a food bar comprising the steps of: (a) cooking a grain with water to gelatinize the starch of the grain, wherein the grain received in a form containing unseparated endosperm and germ, (b) homogenizing the gelatinized starch to produce a smooth mixture; (c) blending the smooth mixture with a fermented dairy product to provide a base material to which other ingredients can be added; (d) forming the base material into a bar form; and (e) allowing the bar form material to solidify by cooling into the food bar after forming.

It is thus a feature of at least one embodiment of the invention to provide a method of directly processing substantially complete grains into a food bar product.

The fermented dairy product may be yogurt, sour cream, ricotta cheese, or cottage cheese.

It is thus a feature of at least one embodiment of the invention to save cost, over using the individual component from milk, improves digestability of the cheese components, and contribute flavor.

The gelatinized starch may be maintained in a heated state above 120 degrees Fahrenheit from the cooking to the solidifying steps.

It is thus a feature of at least one embodiment of the invention to permit an efficient process that uses residual cooking heat for later blending and molding operations.

The step of forming the base material may pour the base material into a mold for cooling or extrude material through a die for cooling to form the bar.

It is thus a feature of at least one embodiment of the invention to provide a base product that may rapidly solidify upon cooling for efficient manufacture.

The grains may be whole grains.

It is thus a feature of at least one embodiment of the invention to provide a food bar that may take advantage of all of the nutritional components of whole grain.

The grains may be white rice.

It is thus a feature of at least one embodiment of the invention to provide a food bar that can be fabricated from a universally tolerated grain.

The invention may include the step of homogenizing the gelatinized starch which subjects the grains to shear without substantial release of water from the grains.

It is thus a feature of at least one embodiment of the invention to provide a smooth base material without undue water release

The method may include the step of adding nuts . . . .

It is thus a feature of at least one embodiment of the invention to provide a food bar that can be produced in different varieties

These particular features and advantages may apply to only some embodiments falling within the claims and thus do not define the scope of the invention.

### DETAILED DESCRIPTION OF THE PREFERRED EMBODIMENT

This invention entails a process for producing a food bar with the primary structural material and carrier being cooked and homogenized grains that include at least the endosperm and germ. The grains may be rice (white or brown), corn, and wheat on or near the site of final manufacturing. The advantage of this process includes cost savings (ingredient and energy), having fresh native starch available, and retaining all other beneficial attributes of the more complete grain.

The homogenized grain can be combined with a variety of food ingredients/products (nuts, dairy products, fruits, sugar, vitamins, minerals proteins, flavor, color, etc.) to produce food bars. This process works in the following types of bars: snack, nutritional, energy, and sport. These bars then can be stored frozen, refrigerated, or at room temperature. This process avoids gums or stabilizers used to produce most of today's food bars. By avoiding certain processed ingredients, the method thereby also improves flavor, nutritional value and texture in foods.

The present application incorporates by reference U.S. Pat. No. 6,645,542, which taught how to use cooked homogenized whole grain rice in extending dairy products. This concept has been expanded the original concept to include homogenizing a variety of grains in the production of food bars.

Traditional grain processing isolates the needed components of the grain (endosperm and germ), further processes those components (heat, acids, enzymes and drying) and sells those ingredients to the food industry to be re-hydrated and used in food formulations. This invention may skip the isolation of the components and drying of the whole grains, which is an energy and cost savings. Generally the moisture content of the grain may exceed 14 percent on a weight basis and may be as high as the moisture content upon harvesting (typically 20 to 25 percent on a weight basis). The fact this process is done on or near the site of final manufacturing of the bar also saves costs. This process also retains heat stable nutrients, color, and flavor characteristics of the grain.

This invention relates to the use of grains received whole or crushed (cracked) and in the case of rice with or without bran. One or a combination of these grains is then mixed with water at no less than 120 degrees Fahrenheit and preferably 140 F or above at ambient pressure or above. The grains are held at these temperatures until soft and then they are homogenized while hot. This slurry of grains can be held for greater than 24 hours and up to 72 hours until needed by the manufacturer. If necessary the homogenized grains can be treated with traditional methods (enzymes, acid, caustic) to modify the starch to specifically meet the needs of the final product however such enzyme treatment is not necessary and may be excluded.

This invention involves receiving grains (whole or ground), cooking the grain, homogenizing the grain, and using that final slurry as an ingredient in the manufacturing of food bars. One goal is to produce a homogeneous slurry through shear or homogenization that can be pumped to the final blending equipment. This slurry is the part of the formula that supplies the starch and structural component of the bar. Prior to pumping the grain slurry, a variety of products can be added to this tank such as flavors, colors, or particulates. The slurry is then pumped into a mixing vessel where other ingredients can be added. This final blend may then be extruded through a die or poured in to molds which forms it into the cross-section of the bar and then cut and packaged or formed by conveying it into a mold and allowing it to cool. This product may be packaged hot or cold and may be coated with a variety of products. This process has several advantages over bars made from traditional methods: one, it may use whole grains, second it may retain all the heat stable nutritional value of the grain, third, it may avoid using isolated processed ingredients, and fourth, it is a cost savings over other ingredients.

The resulting food bar can be any suitable shape and size. In one embodiment, the food bar has a weighted substantially 10 to 12 ounces and is a substantially rectangular shape, for example, having dimensions more than three inches and less than eight inches long, more than one inch and less than three inches wide and more than one quarter inch and less than three quarter inch thick.

### EXAMPLE I

### Sports Energy Bar Formula

25% whole grain rice
34% reduced fat cream cheese
30% sucrose
10% whey protein concentrate
0.01% flavor

To manufacture the bar, the rice is cooked until slightly soft; then sheared (homogenizing) to a smooth and homogeneous state in which individual grains can no longer be discerned while hot at above 120 and at least above 90 degrees Fahrenheit. Then this slurry is combined with the other ingredients and poured into a mold or extruded to obtain the desired shape and size where it is cooled before removing. The reduced fat cream cheese may be substituted with any fermented dairy products including yogurt, cottage cheese, ricotta, and sour cream.

### EXAMPLE II

### Nutritional Supplement Bar—A Fiber Bar

35% whole grain corn
20% whole grain rice
10% oat fiber
15% honey
10% crushed nuts
10% chocolate

To manufacture the fiber bar, the corn and rice are cooked separately or together. Once the grains are slightly soft; shear the grains (homogenizing) to a homogeneous state while hot. Then this slurry is combined With the other ingredients, except chocolate, and poured at a temperature above 90 degrees Fahrenheit into a mold to obtain the desired shape and size. The product is then cooled and removed from the mold and the chocolate is used to enrobe the product.

### Unique Aspects of Using Whole Grain Slurries

Grain slurries can range in solids from very low concentrations to high concentrations as the equipment will handle, shearing, stirring and pumping.

Because the grains are cooked beyond their gelatinization temperatures, the slurry is essentially sterile.

Slurries can be held for several hours (24+) without changing the characteristics of the slurry.

Using freshly made slurries of whole grains to replace starch in food applications not only saves money but energy over the supply chain of dried starches.

A slurry allows addition of other ingredients when the temperature is optimum for retaining the ingredient nutritional value. Example would be heat sensitive vitamins or probiotic organisms.

The whole grain slurries can be enzyme modified in the slurry using heat stable enzymes to modify the starch properties to meet the needs of the application. Example for an energy bar is, to treat the starch with alpha amylase to produce multidextrins for quick energy release. This saves the need to purchase these dextrins.

Whole grain slurries hold flavors better than aqueous solutions thus less flavor is needed.

Certain ingredients can be added to the slurry while hot or warm to facilitate mixing and thus saving time in the final mix step. For example colors, flavors, particulates, sugars, etc.

Whole grain is considered a positive for foods in general, however, most of those products only contain a small percentage of whole gains. This technology may actually incorporate whole grains into the final products.

This slurry process retains all the components of the whole grains, fiber, oils, proteins, minerals etc.

Grains can be blended together to meet unique physical properties in the finished product.

The formulation of the slurry (% solids) can be modified to meet the water activity needs of the final product.

“More complete grain” as used herein means grains in substantially their natural state from the plant with only drying and removal of the hull and/or bran. “Non-milled grain” includes grains subject incidental breakage from shipping and the like but that have not been subject to machine crushing milling or grinding. Non-milled grain is primarily composed of particles greater than 500 micrometers in diameter.

“Whole grain” as used herein means grain that containing the 3 principal components, starchy endosperm, bran, and germ, in the same relative proportions as they exist in the intact grain.

“Non-dried grain” means grain that has not been dried to a moisture content of 14 percent or less and typically having a moisture content of 20 to 25 percent.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

I claim:

1. A method of manufacture of a food bar comprising the steps of:
(a) cooking a grain with water to gelatinize the starch of the grain, wherein the grain received in a form containing unseparated endosperm and germ;
(b) homogenizing the gelatinized starch to produce a smooth mixture;
(c) blending the smooth mixture with a fermented dairy product to provide a base material;
(d) forming the base material into a bar form; and
(e) allowing the bar form material to solidify by cooling into the food bar after forming.

2. The method of claim 1 wherein, the fermented dairy product is selected from the group consisting of yogurt, sour cream, ricotta cheese, cream cheese, and cottage cheese.

3. The method of claim 1 wherein the gelatinized starch is maintained in a heated state above 120 degrees Fahrenheit from step (a)-to step (c)

4. The method of claim 2 wherein the step of forming the base material employs a process selected from the group consisting of pouring the base material into a mold for cooling at step (e) and extruding the base material through a die for cooling at step (e).

5. The method of claim 1 wherein the grains retain the moisture content of greater than 14 percent on a weight basis.

6. The method of claim 1 wherein the gains are whole grains.

7. The method of claim 4 wherein the grains are white rice.

8. The method of claim 1 wherein step (b) subjects the grains to shear without substantial release of water from starch granules of the grain.

9. The method of claim 1 wherein the grain at step is not milled before step (a).

10. The method of claim 1 further including the step of adding a material after step (b) selected from the group consisting of nuts and fruit.

11. The method of claim 1 further including the step of adding material after step (b) selected from the group consisting of protein(s) carbohydrates, simple sugars, vitamins, mineral, fruits, nuts, vegetables, stabilizers, antioxidants, food supplements, probiotics, and or acidulants.

12. The method of claim 1 further including treating the slurry with enzymes to produce multidextrins.
